(19) United States
(12) Patent Application Publication
(10) Pub. No.: US 2015/0345710 A1
(43) Pub. Date: Dec. 3, 2015

(54) STEAM VALVE DRIVING DEVICE AND STEAM VALVE

(71) Applicant: Kabushiki Kaisha Toshiba, Minato-ku (JP)

(72) Inventors: Jiani YU, Fujisawa (JP); Hideo HOSAKA, Yokohama (JP)

(73) Assignee: Kabushiki Kaisha Toshiba, Minato-ku (JP)

(21) Appl. No.: 14/723,895

(22) Filed: May 28, 2015

(30) Foreign Application Priority Data
May 29, 2014 (JP) 2014-111035

(51) Int. Cl. F17D 3/14; F16K 37/00; F17D 5/00; F16K 31/122

(52) U.S. Cl. CPC F17D 3/14; F16K 31/1221; F16K 37/0091; F17D 5/005

(57) ABSTRACT

The steam valve driving device of this embodiment adjusts a flow rate of steam flowing inside a valve box by varying a distance between a valve seat and a valve element connected to a valve stem in the valve box. The steam valve driving device has an oil cylinder and a spring box. Here, an inlet and an outlet are formed in the spring box. Then, the air from the outside of the spring box is supplied into the spring box from the inlet of the spring box so as to make a pressure in the spring box higher than that of the outside, and is discharged from the outlet of the spring box.

### CROSS REFERENCE TO RELATED APPLICATION

This application is based upon and claims the benefit of priority from Japanese Patent Application No. 2014-111035, filed on May 29, 2014; the entire contents of which are incorporated herein by reference.

### FIELD

Embodiments described herein relate generally to a steam valve driving device and a steam valve.

### BACKGROUND

In a steam turbine system, a steam valve is installed in a pipe and the steam valve adjusts a flow rate and so on of steam that is to be sent to a steam turbine.

[A] Structure of Steam Valve

FIG. 8 is a view schematically illustrating the profile of a steam valve in a related art. In FIG. 8, a vertical plane (xz plane) along a vertical direction (z axis) is illustrated. In FIG. 8, the flow of steam is depicted by the thick solid line arrows and part of the steam valve is illustrated in section.

As illustrated in FIG. 8, the steam valve V1 has a steam valve main body part 10, a steam valve driving part 30 (steam valve driving device), and a yoke part 50, and is structured so that the steam valve driving part 30 adjusts a flow rate of the steam by driving the steam valve main body part 10. These parts are each formed by using a metal material.

The parts forming the steam valve V1 will be sequentially described in detail.

[A-1] Steam Valve Main Body Part 10

As illustrated in FIG. 8, the steam valve main body part 10 has a valve box 11 (valve casing), an upper cover 12, a valve seat 13, a valve stem 14, and a valve element 15. In the steam valve main body part 10, a distance between the valve seat 13 and the valve element 15 varies in an inner space 11c of the valve box 11, whereby the flow rate of the steam flowing in the inner space 11C is adjusted.

In the valve box 11 of the steam valve main body part 10, an inlet 11A and an outlet 11B are formed. In the valve box 11, steam F11 flows into the inner space 11C from the inlet 11A when the steam valve V1 is opened, and after the steam F11 flows in the inner space 11C, steam F12 flows to the outside from the outlet 11B. Further, the valve box 11 has an opening 11K formed in its upper portion and a through hole 11T formed in its lower portion.

The upper cover 12 of the steam valve main body part 10 is installed on the upper portion of the valve box 11 to close the opening 11K formed in the upper portion of the valve box 11.

The valve seat 13 of the steam valve main body part 10 is installed in the inner space 11C of the valve box 11. The valve seat 13 is fixed on an inner peripheral surface of the valve box 11 and includes a portion with which the valve element 15 comes into contact.

The valve stem 14 of the steam valve main body part 10 is installed so as to penetrate through the through hole 11T formed in the lower portion of the valve box 11. The valve stem 14 is, for example, a rod-shaped body, and is provided so that its axis 14J is along the vertical direction (z axis) and it moves along the vertical direction (z axis) along which the axis 14J is set.

The valve element 15 of the steam valve main body part 10 is housed in the inner space 11C of the valve box 11. The valve element 15 is connected to one end (upper end in FIG. 8) of the valve stem 14 and moves in the vertical direction (z axis) along the axis 14J together with the valve stem 14. The valve element 15 separates from the valve seat 13 when the steam valve V1 is opened, and approaches and comes into contact with the valve seat 13 when the steam valve V1 is closed.

[A-2] Steam Valve Driving Part 30 (Steam Valve Drive)

As illustrated in FIG. 8, the steam valve driving part 30 is installed under the steam valve main body part 10 in the vertical direction (z axis) and has an operation rod 31, an oil cylinder 32, and a spring box 33 (spring casing). The steam valve driving part 30 is structured to open the steam valve V1 by an action of an oil pressure and closes the steam valve V1 by an action of a resilient force of a spring. That is, the steam valve driving part 30 varies the distance between the valve seat 13 and the valve element 15 connected to the valve stem 14 in the inner space 11C of the valve box 11 to thereby adjust the flow rate of the steam flowing in the inner space 11C of the valve box 11.

The operation rod 31 of the steam valve driving part 30 is a rod-shaped body and its axis 31J is along the vertical direction (z axis). The operation rod 31 is coaxial with the axis 14J of the valve stem 14 forming the steam valve main body part 10 and has one end (upper end in FIG. 8) connected to the valve stem 14. Here, a coupling 311 is provided at the one end (upper end in FIG. 8) of the operation rod 31, a coupling 141 is provided at the other end (lower end in FIG. 8) of the valve stem 14, and the coupling 311 of the operation rod 31 and the coupling 141 of the valve stem 14 are connected. Further, a piston 31P is connected to the other end (lower end in FIG. 8) of the operation rod 31.

The oil cylinder 32 of the steam valve driving part 30 is, for example, a cylinder having a cylindrical shape and houses the piston 31P therein. The oil cylinder 32 forms a hydraulic driving mechanism and the piston 31P moves in the vertical direction (z axis) according to the oil pressure.

The spring box 33 of the steam valve driving part 30 is located between the valve box 11 and the oil cylinder 32 via the yoke part 50 in the vertical direction (z axis). Through the spring box 33, the operation rod 31 penetrates in the vertical direction (z axis) and the spring box 33 houses an operating spring 33D in its inner housing space 33S. The operating spring 33D of the spring box 33 is structured to expand and contract in the housing space 33S by the operation rod 31 operated by the piston 31P. Concretely, the spring box 33 has a body portion 331, a first plate portion 332, and a second plate portion 333, and the housing space 33S is formed by the body portion 331, the first plate portion 332, and the second plate portion 333. The body portion 331 of the spring box 33 is a tubular body in a cylindrical shape and is installed so as to be coaxial with the axis 31J of the operation rod 31. The first plate portion 332 of the spring box 33 is a plate-like body having a disk shape and is installed on an upper portion of the body portion 331. In the first plate portion 332, a through hole 332T is formed, and the operation rod 31 penetrates through the through hole 332T. The second plate portion 333 of the spring box 33 is a plate-like body having a disk shape similarly to the first plate portion 332 and is installed on a lower portion of the body portion 331. In the second plate portion 333, a through hole 333T is formed, and the operation rod 31 penetrates through the through hole 333T.

The operating spring 33D is, for example, a disk spring and through its center, the operation rod 31 penetrates. The operating spring 33D is provided between a spring bearing 31R fixed to the operation rod 31 and the first plate portion 332 of the spring box 33, in the housing space 33S of the spring box 33.

In the housing space 33S of the spring box 33, a distance between the spring bearing 31R and the first plate portion 332 varies in accordance with the movement of the operation rod 31. Consequently, the operating spring 33D deforms to expand and contract in the vertical direction (z axis) along the axis 31J of the operation rod 31.

[A-3] Yoke Part 50

As illustrated in FIG. 8, the yoke part 50 is located under the steam valve main body part 10 and above the steam valve driving part 30 in the vertical direction (z axis), and has a first flange portion 51, a second flange portion 52, and a connecting portion 53. The yoke part 50 is structured to connect the steam valve main body part 10 and the steam valve driving part 30.

The first flange portion 51 of the yoke part 50 is installed on the steam valve main body part 10. The first flange portion 51 is a plate-like body having a ring shape and at its center, a through hole 51T is formed. Here, an upper surface of the first flange portion 51 is in contact with a lower surface of the valve box 11 in the steam valve main body part 10, and the valve stem 14 penetrates through the through hole 51T of the first flange portion 51.

The second flange portion 52 of the yoke part 50 is installed on the steam valve driving part 30. The second flange portion 52 is a plate-like body having a ring shape similarly to the first flange portion 51, and at its center, a through hole 52T is formed. Here, a lower surface of the second flange portion 52 is in contact with an upper surface of the spring box 33 in the steam valve driving part 30, and the operation rod 31 penetrates through the through hole 52T of the second flange portion 52.

The connecting portion 53 of the yoke part 50 is interposed between the first flange portion 51 and the second flange portion 52 to connect the first flange portion 51 and the second flange portion 52. Here, the connecting portion 53 is provided in plurality, and the plural connecting portions 53 are disposed on peripheral edges of facing surfaces of the first flange portion 51 and the second flange portion 52.

[B] Problems and Measures

In the above, the valve stem 14 of the steam valve main body part 10 penetrates through the valve box 11, and therefore, the steam, though only slightly, leaks from the steam valve main body part 10 through a gap between the valve stem 14 and the valve box 11. The leaking steam sometimes enters the housing space 33S of the spring box 33 forming the steam valve driving part 30 (steam valve driving device). Due to the steam leaking from the steam valve main body part 10, the steam sometimes enters the housing space 33S of the spring box 33 from a gap present between the operation rod 31 and the spring box 33. Besides, the steam leaking from the steam valve main body part 10 is cooled to be liquefied and sometimes enters the housing space 33S of the spring box 33 in a liquid state.

As a result, in the housing space 33S of the spring box 33, the operating spring 33D formed of the metal material such as copper sometimes rusts to break. Further, an inner surface of the spring box 33 similarly formed of a metal material sometimes corrodes.

As a measure for such a problem, various methods have been proposed.

FIG. 9 is a cross-sectional view schematically illustrating the spring box portion forming the steam valve driving part in the related art.

As illustrated in FIG. 9, it has been proposed to radially form a plurality of drain holes 52D in the second flange portion 52 installed on the upper surface of the spring box 33 so as to make an inner peripheral surface and an outer peripheral surface of the second flange portion 52 communicate with each other, in order to discharge water entering the spring box 33, from the plural drain holes 52D. Further, it has been proposed to provide a raised portion 332A on the upper surface of the spring box 33 so as to surround an outer peripheral surface of the operation rod 31, in order to make the water difficult to enter the spring box 33. Further, it has been proposed to form drain holes 333D in the lower surface of the spring box 33 and install filters 333F in the drain holes 333D, in order to make it difficult for the water to pool in the spring box 33.

However, in the above-described related art, the entrance of the water to the housing space 33S of the spring box 33 is not sufficiently prevented and the water is not sufficiently discharged from the housing space 33S. Consequently, it is not possible for the housing space 33S of the spring box 33 to have a sufficiently dried state. As a result, it is not sometimes easy to effectively prevent the corrosion and the like of the spring box 33 and the operating spring 33D.

Therefore, a problem to be solved by the present invention is to provide a steam valve driving device and a steam valve which make it possible to easily prevent the corrosion and the like of a spring box and an operating spring.

### BRIEF DESCRIPTION OF THE DRAWINGS

FIG. 1 is a view illustrating the whole structure of a steam valve in a first embodiment.

FIG. 2 is a cross-sectional view schematically illustrating a spring box forming a steam valve driving part in the first embodiment.

FIG. 3 is a cross-sectional view schematically illustrating a spring box forming a steam valve driving part in a modification example of the first embodiment.

FIG. 4 is a cross-sectional view schematically illustrating a spring box forming a steam valve driving part in a modification example of the first embodiment.

FIG. 5 is a view illustrating the whole structure of a steam valve in a second embodiment.

FIG. 6 is a view illustrating the whole structure of a steam valve in a third embodiment.

FIG. 7 is a view illustrating the whole structure of a steam valve in a fourth embodiment.

FIG. 8 is a view schematically illustrating the profile of a steam valve in a related art.

FIG. 9 is a cross-sectional view schematically illustrating a spring box portion forming the steam valve driving part in the related art.

### DETAILED DESCRIPTION

A steam valve driving device of this embodiment adjusts a flow rate of steam flowing inside a valve box by varying a distance between a valve seat and a valve element connected to a valve stem inside the valve box. The steam valve driving device has an oil cylinder and a spring box. The oil cylinder houses a piston connected to the valve stem via an operation rod, and the piston is actuated according to an oil pressure. The spring box is penetrated by the operation rod and the spring box houses an operating spring therein. When the operation rod is operated by the activation of the piston, the operating spring expands and contracts. Here, in the spring box, an inlet and an outlet are formed. The air from the outside of the spring box is supplied into the spring box from the inlet of the spring box so that a pressure in the spring box becomes higher than that of the outside, and the air is discharged from the outlet of the spring box.

Embodiments will be described with reference to the drawings.

### First Embodiment

### [A] Structure and so on

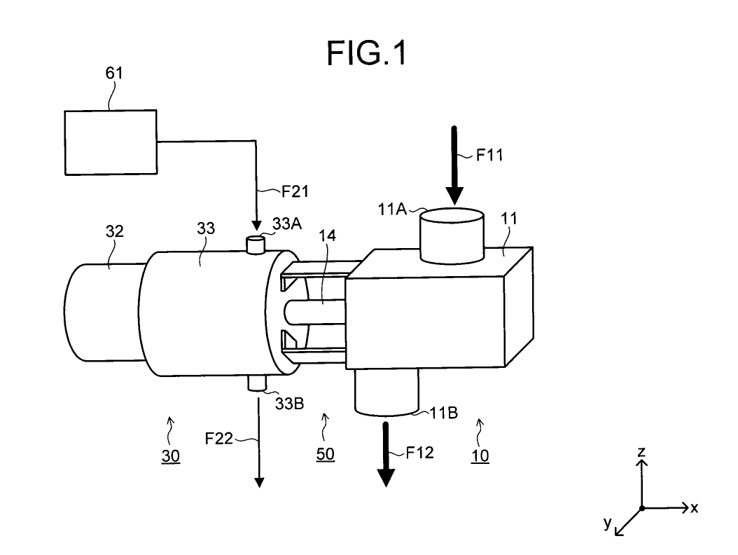

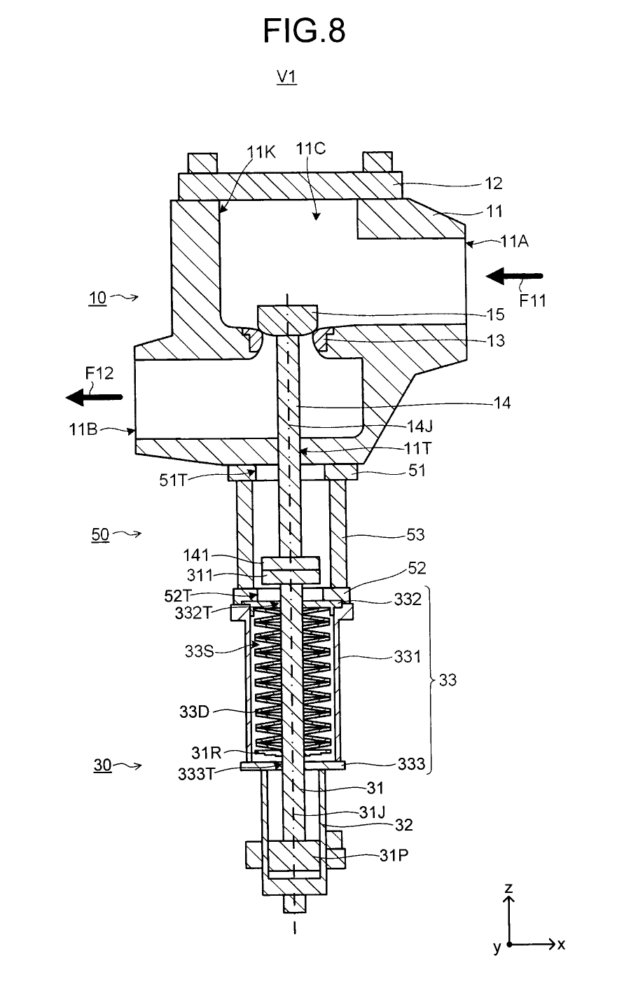

FIG. 1 is a view illustrating the whole structure of a steam valve in a first embodiment. FIG. 1 is a perspective view and schematically illustrates an essential part of the steam valve. In FIG. 1, as in FIG. 8, the flow of steam is depicted by the thick solid line arrows. In addition, in FIG. 1, the flow of the air is depicted by the thin solid line arrows.

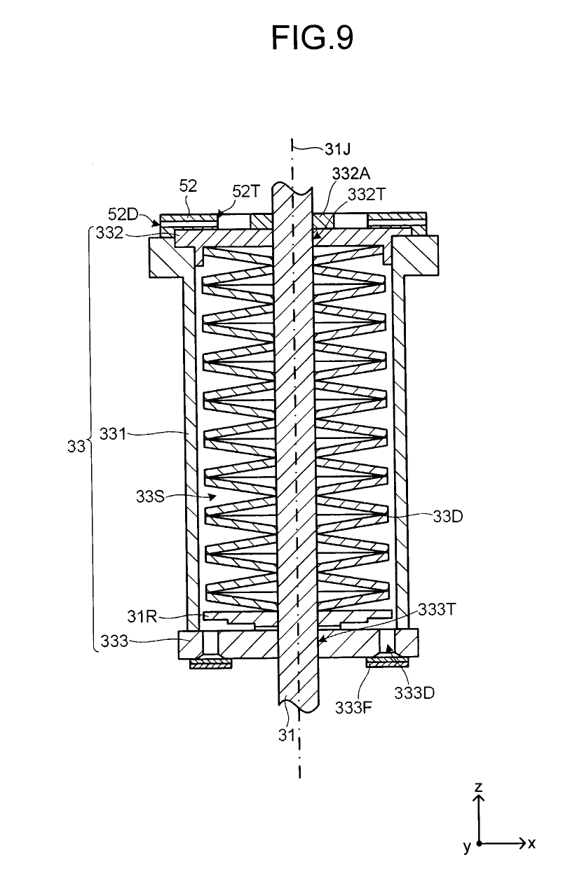

As illustrated in FIG. 1, in this embodiment, the steam valve V1 has a steam valve main body part 10, a steam valve driving part 30 (steam valve driving device), and a yoke part 50, as is the case in the above-described related art (refer to FIG. 8 and FIG. 9). However, in this embodiment, the steam valve main body part 10, the steam valve driving part 30, and the yoke part 50 are not disposed along a vertical direction (z axis), but are disposed along one horizontal direction (x axis) on a horizontal plane (xy plane). That is, the steam valve main body part 10, the steam valve driving part 30, and the yoke part 50 are not arranged in a longitudinal direction but are arranged in a lateral direction. Further, part of the steam valve driving part 30 is different from that in the above-described related art.

This embodiment is the same as the case of the above-described related art except in these points and points related to these. Therefore, in this embodiment, a description of what are the same as those described above will be omitted when appropriate.

The parts forming the steam valve V1 in this embodiment will be sequentially described.

### [A-1] Steam Valve Main Body Part 10

In the steam valve V1, the steam valve main body part 10, though the illustration of part thereof is omitted in FIG. 1, is structured the same as in the case of the above-described related art. That is, in the steam valve main body part 10, a valve seat 13 and a valve element 15 connected to a valve stem 14 are housed inside a valve box 11 as described above. Further, the steam valve main body part 10 is structured to adjust a flow rate of steam flowing in the steam valve V1 by varying a distance between the valve seat 13 and the valve element 15 in an inner space 11C of the valve box 11 (refer to FIG. 8).

### [A-2] Yoke Part 50

In the steam valve V1, the yoke part 50, though the illustration of part thereof is omitted in FIG. 1, is structured the same as in the case of the above-described related art. That is, the yoke part 50 has a first flange portion 51, a second flange portion 52, and a connecting portion 53 as described above. The yoke part 50 connects the valve box 11 forming the steam valve main body part 10 and a spring box 33 forming the steam valve driving part 30 (refer to FIG. 8 and FIG. 9).

### [A-3] Steam Valve Driving Part 30

In the steam valve V1, the steam valve driving part 30, though the illustration of part thereof is omitted in FIG. 1, is structured the same as in the case of the above-described related art. That is, the steam valve driving part 30 has an operation rod 31, an oil cylinder 32, and the spring box 33 as described above. Further, the steam valve driving part 30 is structured so that an operating spring 33D expands and contracts in the spring box 33 by a piston 31P being activated in the oil cylinder 32 by an oil pressure (refer to FIG. 8 and FIG. 9).

The operation rod 31 of the steam valve driving part 30, though its illustration is omitted in FIG. 1, has one end connected to the valve stem 14 on which the valve element 15 housed in the valve box 11 is provided and has the other end to which the piston 31P is connected (refer to FIG. 8 and FIG. 9), as is the case in the above-described related art.

The oil cylinder 32 of the steam valve driving part 30, though the illustration of part thereof is omitted in FIG. 1, houses therein the piston 31P connected to the valve stem 14 of the steam valve main body part 10 via the operation rod 31, as is the case in the above-described related art (refer to FIG. 8 and FIG. 9). In this embodiment, as is understood from FIG. 1, the oil cylinder 32 is structured so that the piston 31P moves therein in the one horizontal direction (x axis) by the oil pressure, as is not the case in the above-described related art.

Through the spring box 33 of the steam valve driving part 30, though the illustration of part thereof is omitted in FIG. 1, the operation rod 31 penetrates, and the spring box 33 houses the operating spring 33D therein, as is the case in the above-described related art (refer to FIG. 8).

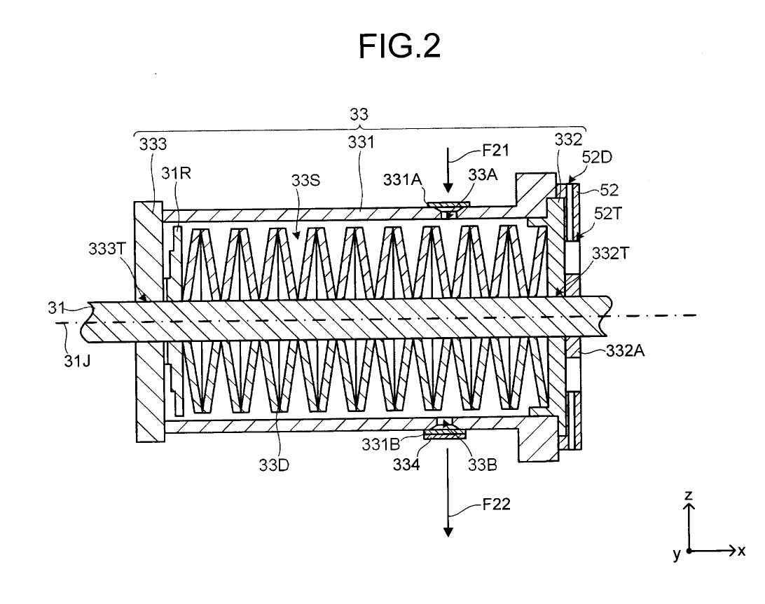

FIG. 2 is a cross-sectional view schematically illustrating the spring box forming the steam valve driving part (steam valve driving device) in the first embodiment.

As illustrated in FIG. 2, the spring box 33 has a body portion 331, a first plate portion 332, and a second plate portion 333, as is the case in the above-described related art (refer to FIG. 8). In the spring box 33, the body portion 331, the first plate portion 332, and the second plate portion 333 form a housing space 33S. Then, in the spring box 33, the operation rod 31 penetrates through the first plate portion 332 and the second plate portion 333 in the one horizontal direction (x axis), and the operating spring 33D is housed in the housing space 33S. In the housing space 33S of the spring box 33, in accordance with the movement of the operation rod 31, a distance between a spring bearing 31R and the first plate portion 332 varies, so that the operating spring 33D deforms to expand and contract in the one horizontal direction (x axis).

In this embodiment, in the spring box 33, an inlet 33A and an outlet 33B are formed as illustrated in FIG. 1 and FIG. 2, as is not the case in the above-described related art.

Concretely, the inlet 33A and the outlet 33B are both formed in the body portion 331 of the spring box 33 as illustrated in FIG. 1 and FIG. 2. Here, in the body portion 331, the inlet 33A and the outlet 33B are both formed so as to be located on a side (right side in FIG. 2) closer to the valve box 11 in the one horizontal direction (x axis).

In the body portion 331, the inlet 33A is formed at a portion located on an upper side in the vertical direction (z axis) as illustrated in FIG. 1 and FIG. 2. Here, as illustrated in FIG. 2, the inlet 33A is formed at a highest top portion of the body portion 331. Further, on the inlet 33A, an air supply seat 331A is installed.

In the body portion 331, the outlet 33B is formed at a portion located on a lower side in the vertical direction (z axis) as illustrated in FIG. 1 and FIG. 2. Here, as illustrated in FIG. 2, the outlet 33B is formed at a lowest bottom portion of the body portion 331. On the outlet 33B, an exhaust seat 331B is installed. Further, on the outlet 33B, a filter 334 is installed as illustrated in FIG. 2.

In this embodiment, as illustrated in FIG. 1, an air supply part 61 (air supply) is provided as an air purge part, and the air supply part 61 performs air purging of the housing space 33S of the spring box 33 by supplying the air F21 to the inlet 33A of the spring box 33. Here, by supplying the air F21 higher in pressure than the atmosphere, a pressure in the spring box 33 is kept at a constant value higher than the outside pressure. After flowing in a pipe from the air supply part 61, the air F21 flows into the spring box 33 through a hole of the seat 331A installed on the inlet 33A in the spring box 33. For example, the air F21 used in an instrumentation device (not illustrated) in a power station (not illustrated) is constantly supplied into the spring box 33.

Then, the air F22 is discharged to the outside from the outlet 33B of the spring box 33. Here, the air F22 flows to the outside of the spring box 33 through a hole of the seat 331B installed on the outlet 33B in the spring box 33 and the filter 334. In this embodiment, the air F22 is released to the atmosphere. That is, this flow of the air forms an open cycle.

### [B] Summary (Effect and so on)

As described above, in the steam valve driving part 30 of this embodiment, the inlet 33A and the outlet 33B are formed in the spring box 33. Then, the air is supplied to the housing space 33S of the spring box 33 so that the pressure of the housing space 33S housing the operating spring 33D in the spring box 33 is kept higher than that of the outside.

Consequently, in this embodiment, even if the steam tries to leak from a gap between the valve box 11 and the valve stem 14, the steam is bounced back because the inside of the spring box 33 is kept at a higher pressure than that of the outside. Consequently, the steam flows in a gap between the operation rod 31 and the spring box 33, which can prevent the steam from entering the housing space 33S of the spring box 33. Further, in this embodiment, even if the steam enters the housing space 33S of the spring box 33, the high-pressure air is discharged from the outlet 33B. Accordingly, water pooling in the housing space 33S due to the steam can be discharged to the outside from the housing space 33S of the spring box 33. That is, in the steam valve driving part 30, the air purging of the housing space 33S of the spring box 33 is performed.

As a result, in this embodiment, it is possible to prevent the operating spring 33D housed in the housing space 33S of the spring box 33 from becoming rusty. Further, in this embodiment, it is possible to prevent the corrosion of an inner peripheral surface of the spring box 33. Therefore, in this embodiment, it is possible to effectively prevent a breakage of the operating spring 33D and so on, which can improve reliability of the steam valve driving part 30 (steam valve driving device).

In particular, in this embodiment, the inlet 33A is formed at the upper portion of the spring box 33 and the outlet 33B is formed at the lower portion of the spring box 33. Therefore, in this embodiment, the air supplied into the spring box 33 via the inlet 33A flows in the same direction as the gravity and is discharged to the outside of the spring box 33 via the outlet 33B. Therefore, in this embodiment, the water pooling in the housing space 33S of the spring box 33 can be more effectively discharged to the outside. As a result, in this embodiment, it is possible to more effectively prevent the breakage and so on of the operating spring 33D.

### [C] Modification Examples

### [C-1] Modification Example 1-1

In the above-described embodiment, the steam valve main body part 10, the steam valve driving part 30, and the yoke part 50 are disposed along the horizontal direction (x axis), but this is not restrictive. As is the case in the related art (refer to FIG. 8), the steam valve main body part 10, the steam valve driving part 30, and the yoke part 50 may be disposed along the vertical direction (z axis). That is, the steam valve main body part 10, the steam valve driving part 30, and the yoke part 50 may be arranged in the longitudinal direction instead of being arranged in the lateral direction.

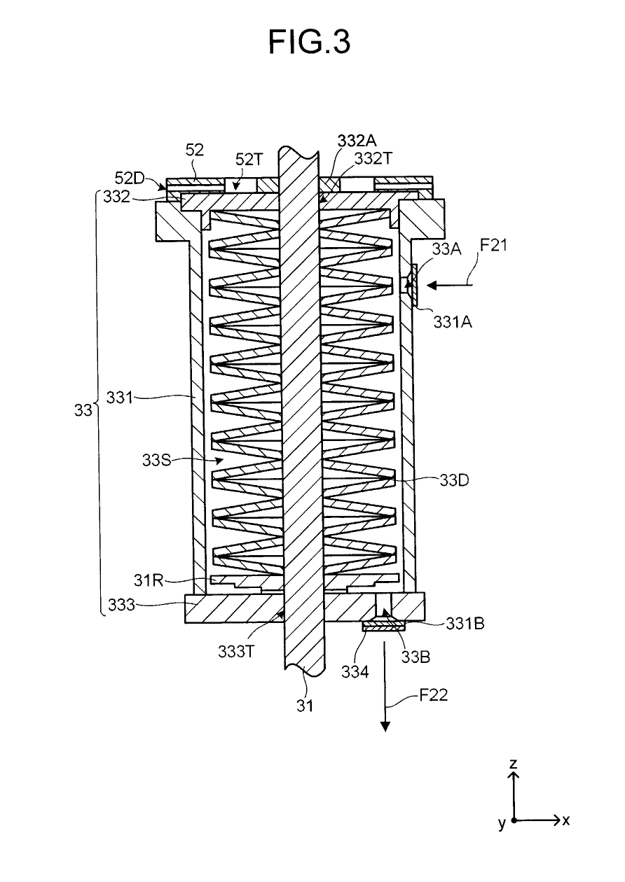

FIG. 3 is a cross-sectional view schematically illustrating a spring box forming a steam valve driving part (steam valve driving device) in a modification example of the first embodiment. FIG. 3 illustrates a case where a steam valve main body part 10, a steam valve driving part 30, and a yoke part 50 are arranged in the longitudinal direction.

In this case as well, it is preferable to form an inlet 33A at an upper portion of a spring box 33 and form an outlet 33B at a portion, of the spring box 33, lower than the inlet 33A, as illustrated in FIG. 3. For example, in a body portion 331 forming the spring box 33, the inlet 33A is formed at a portion located on an upper side. Further, the outlet 33B is formed in a second plate portion 333 located on a lower side of the body portion 331 of the spring box 33.

As is the case in the above-described embodiment, the air is supplied into the spring box 33 via the inlet 33A. Consequently, a pressure in the spring box 33 is kept at a constant value higher than that of the outside. Therefore, as is the case in the above-described embodiment, it is possible to effectively prevent a breakage of an operating spring 33D.

### [C-2] Modification Example 1-2

In the above-described embodiment, in the body portion 331 of the spring box 33, the inlet 33A and the outlet 33B are both located on the side (right side in FIG. 2) closer to the valve box 11, but this is not restrictive.

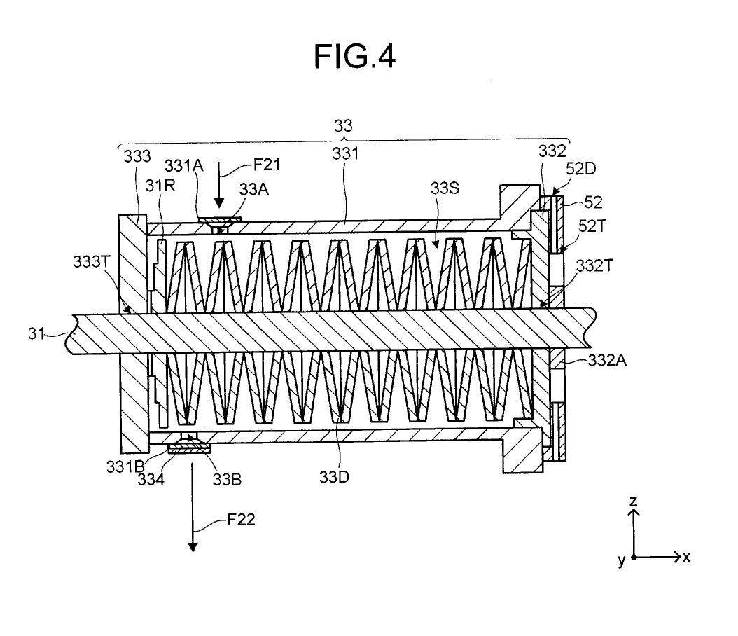

FIG. 4 is a cross-sectional view schematically illustrating a spring box forming a steam valve driving part (steam valve driving device) in a modification example of the first embodiment.

As illustrated in FIG. 4, in a body portion 331, an inlet 33A and an outlet 33B may both be formed on a side (left side in FIG. 4) closer to an oil cylinder 32 (refer to FIG. 1) instead of a side (right side in FIG. 4) closer to a valve box 11.

### Second Embodiment

### [A] Structure

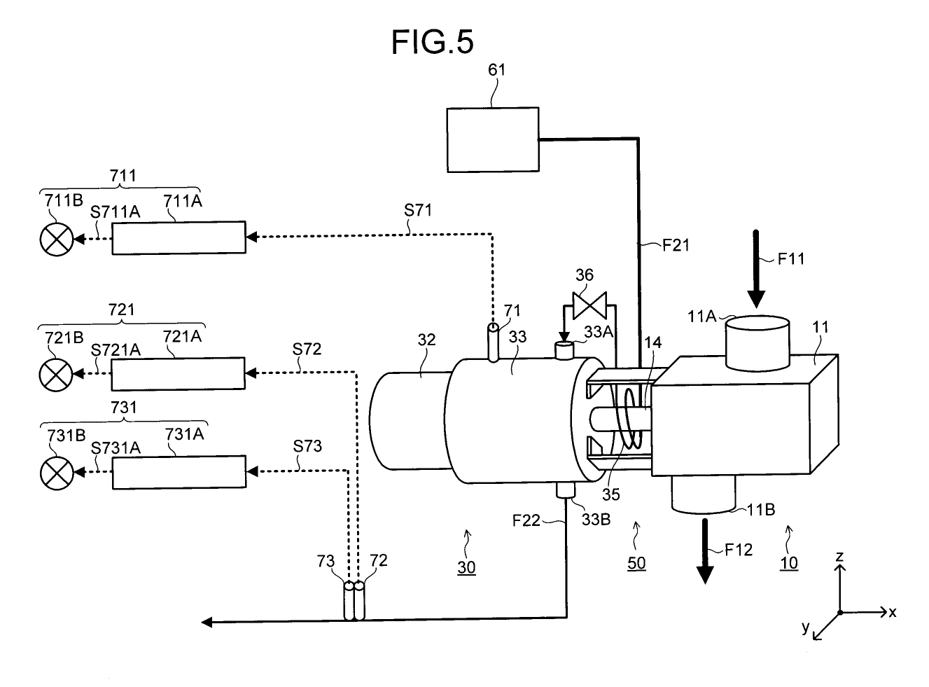

FIG. 5 is a view illustrating the whole structure of a steam valve in a second embodiment. In FIG. 5, as in FIG. 1, part thereof is illustrated in a perspective view, and an essential part is schematically illustrated. In FIG. 5, as in FIG. 1, the flow of steam is depicted by the thick solid line arrows, and the flow of the air is depicted by the thin solid line arrows. In addition, in FIG. 5, the flows of signals are depicted by the broken line arrows.

As illustrated in FIG. 5, in this embodiment, as is the case in the above-described first embodiment (refer to FIG. 1 and so on), a steam valve main body part 10, a steam valve driving part 30, and a yoke part 50 are provided. However, in this embodiment, a part functioning as an air purge part of the steam valve driving part 30 is different from that of the above-described first embodiment. This embodiment is the same as the above-described first embodiment except in this point and points related to this. Therefore, in this embodiment, a description of what are the same as those described above will be omitted when appropriate.

In this embodiment, in the steam valve driving part 30, though the illustration of part thereof is omitted, an inlet 33A and an outlet 33B are formed in a spring box 33 as is the case in the above-described first embodiment. Then, the air F21 is supplied into the spring box 33 from the inlet 33A of the spring box 33 so that a pressure in the spring box 33 becomes higher than that of the outside.

As is not the case in the above-described first embodiment, this embodiment is structured such that the air F21 that is to be supplied to the inlet 33A of the spring box 33 is heated in a heating part 35. Here, the heating part 35 is formed in the yoke part 50. Concretely, in the heating part 35, a pipe in which the air F21 that is to be supplied to the inlet 33A of the spring box 33 from an air supply part 61 flows includes a portion formed in a spiral shape around a valve stem 14, and the air F21 is heated in this portion. For example, by using heat of the steam valve main body part 10 which has been brought into a high-temperature state by the steam, the air F21 is heated.

In this embodiment, as is not the case in the above-described first embodiment, an air adjusting part 36 (air adjustment) is provided. The air adjusting part 36 includes a reducing valve, for instance. In the air adjusting part 36, the reducing valve is installed in a pipe in which the air F21 that is to be supplied to the inlet 33A of the spring box 33 flows, and a flow rate of the air F21 is adjusted by an opening/closing operation of the reducing valve. Here, the air adjusting part 36 adjusts the flow rate of the air F21 that is to be supplied to the spring box 33 so that the pressure in the spring box 33 becomes higher than that of the outside.

Further, in this embodiment, as is not the case in the above-described first embodiment, a pressure measuring part 71 and a pressure warning part 711 are provided. The pressure measuring part 71 includes a pressure sensor, measures the pressure in the spring box 33, and outputs data S71 of the measured pressure. The pressure warning part 711 includes an information processing device 711A and a warning device 711B (alarm) and gives a warning based on the pressure measured by the pressure measuring part 71. Here, the information processing device 711A of the pressure warning part 711 outputs a control signal S711A to the warning device 711B according to the pressure data S71 output by the pressure measuring part 71.

Concretely, when the pressure measured by the pressure measuring part 71 falls out of a predetermined range, the information processing device 711A outputs the control signal S711A to the warning device 711B. Then, according to the control signal S711A, the warning device 711B gives the warning. For example, the warning device 711B includes a warning lamp and a warning sound output device, and when the pressure measured by the pressure measuring part 71 falls out of the predetermined range, the warning lamp is lighted and the warning sound output device outputs a warning sound.

Further, in this embodiment, as is not the case in the above-described first embodiment, a temperature measuring part 72 and a temperature warning part 721 are provided. The temperature measuring part 72 includes a temperature sensor, measures a temperature of the air F22 flowing out of the outlet 33B of the spring box 33, and outputs data S72 of the measured temperature. The temperature warning part 721 includes an information processing device 721A and a warning device 721B (alarm) and gives a warning based on the temperature measured by the temperature measuring part 72. Here, the information processing device 721A of the temperature warning part 721 outputs a control signal S721A to the warning device 721B according to the temperature data S72 output by the temperature measuring part 72.

Concretely, when the temperature measured by the temperature measuring part 72 falls out of a predetermined range, the information processing device 721A outputs the control signal S721A to the warning device 721B. Then, according to the control signal S721A, the warning device 721B gives the warning. For example, similarly to the above, the warning device 721B includes a warning lamp and a warning sound output device, and when the temperature measured by the temperature measuring part 72 falls out of the predetermined range (for example, when it is lower than a saturation temperature), the warning lamp is lighted and the warning sound output device outputs a warning sound.

Further, in this embodiment, as is not the case in the above-described first embodiment, a humidity measuring part 73 and a humidity warning part 731 are provided. The humidity measuring part 73 includes a humidity sensor, measures humidity of the air F22 flowing out from the outlet 33B of the spring box 33, and outputs data S73 of the measured humidity. The humidity warning part 731 includes an information processing device 731A and a warning device 731B (alarm) and gives a warning based on the humidity measured by the humidity measuring part 73. Here, the information processing device 731A of the humidity warning part 731 outputs a control signal S731A to the warning device 731B according to the humidity data S73 output by the humidity measuring part 73.

Concretely, when the humidity measured by the humidity measuring part 73 falls out of a predetermined range, the information processing device 731A outputs the control signal S731A to the warning device 731B. Then, according to the control signal S731A, the warning device 731B gives the warning. For example, the warning device 731B, similarly to the above, includes a warning lamp and a warning sound output device, and when the humidity measured by the humidity measuring part 73 falls out of the predetermined range, the warming lamp is lighted and the warning sound output device outputs a warning sound.

### [B] Summary (Effect and so on)

As described above, in this embodiment, the air F21 that is to be supplied to the inlet 33A of the spring box 33 is heated by the heating part 35. Therefore, in this embodiment, it is possible to prevent the generation of dew condensation in the spring box 33.

In this embodiment, the pressure measuring part 71 and the pressure warning part 711 are installed. Therefore, the pressure in the spring box 33 can be easily monitored.

In this embodiment, the temperature measuring part 72 and the temperature warning part 721 are provided, and the humidity measuring part 73 and the humidity warning part 731 are provided. Therefore, it can be easily found whether or not the dew condensation and the like are generated in the spring box 33.

Further, in this embodiment, the air adjusting part 36 is provided. Therefore, since the flow rate of the air F21 that is to be supplied to the spring box 33 can be adjusted, the pressure in the spring box 33 can be easily brought into a proper state. For example, when the pressure warning part 711, the temperature warning part 721, and the humidity warning part 731 give the warnings, it is possible to bring the pressure into the proper state by adjusting the flow rate of the air F21 that is to be supplied to the spring box 33.

Therefore, in this embodiment, it is possible to effectively prevent a breakage and so on of an operating spring 33D.

### [C] Modification Example

As described above, in this embodiment, the case where the air F21 that is to be supplied to the inlet 33A of the spring box 33 is heated in the yoke part 50 is described, but this is not restrictive. Also adoptable is a structure in which the heating part 35 has a heat exchanger, and the air F21 that is to be supplied to the inlet 33A of the spring box 33 is heated by using the heat exchanger.

Besides, also adoptable is a structure in which the warning is given according to the result obtained by appropriately combining the pressure data S71, the temperature data S72, and the humidity data S73.

### Third Embodiment

### [A] Structure

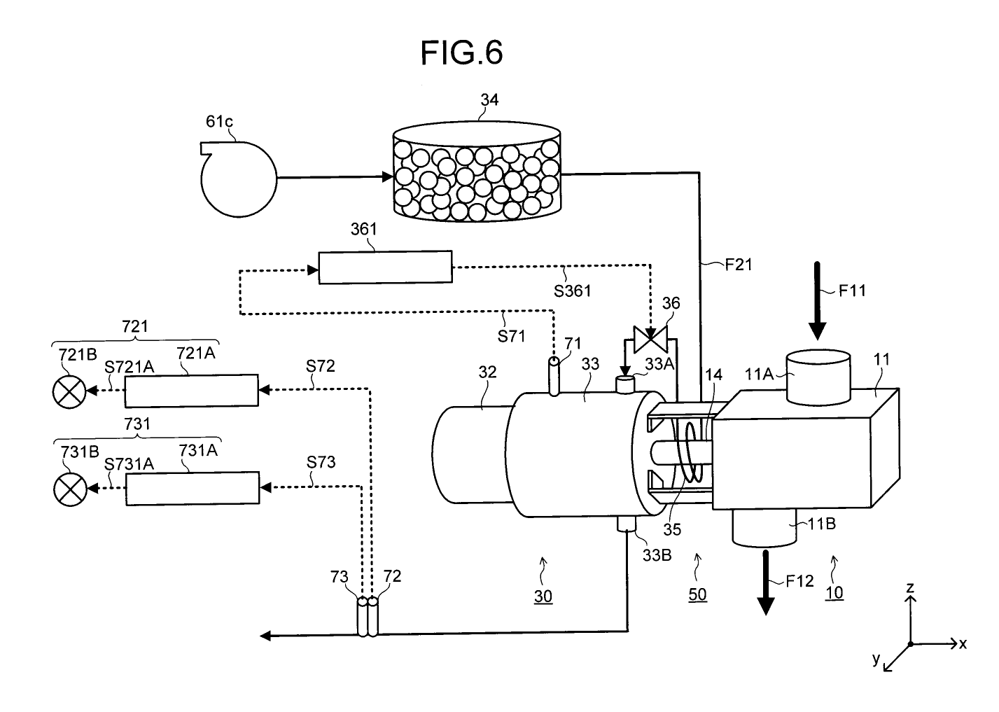

FIG. 6 is a view illustrating the whole structure of a steam valve in a third embodiment. In FIG. 6, as in FIG. 5, part thereof is illustrated in a perspective view and an essential part is schematically illustrated. In FIG. 6, as in FIG. 5, the flow of steam is depicted by the thick solid line arrows, and the flow of the air is depicted by the thin solid line arrows. In addition, in FIG. 6, the flows of signals are depicted by the broken line arrows.

As illustrated in FIG. 6, in this embodiment, as is the case in the above-described second embodiment (refer to FIG. 5), a steam valve main body part 10, a steam valve driving part 30, and a yoke part 50 are provided. However, in this embodiment, the structure of the steam valve driving part 30 is partly different from that of the above-described second embodiment. Here, a part functioning as an air purge part of the steam valve driving part 30 is different from that of the above-described second embodiment. This embodiment is the same as the case of the above-described second embodiment except in this point and points related to this. Therefore, in this embodiment, a description of what are the same as those described above will be omitted when appropriate.

In this embodiment, as is not the case in the second embodiment (refer to FIG. 5), an air supply part 61c does not supply the air F21 used in an instrumentation device (not illustrated) in a power plant (not illustrated), into a spring box 33. In this embodiment, the air supply part 61c includes an air blower, and by the air blower sending the atmospheric air, the air F21 is supplied.

Further, in this embodiment, as is not the case in the second embodiment (refer to FIG. 5), a moisture separating part 34 is provided. The moisture separating part 34 is structured to separate moisture contained in the air F21 that is to be supplied to an inlet 33A of the spring box 33. For example, the moisture separating part 34 is a moisture separating device (moisture seperator) including silica gel, and by the silica gel absorbing the moisture contained in the air F21 sent from the air blower of the air supply part 61c via a pipe, the moisture separating part 34 removes the moisture from the air F21. Then, in this embodiment, the air F21 whose moisture is separated and removed by the moisture separating part 34 flows in a pipe and is heated by the yoke part 50, and thereafter is supplied to the inlet 33A of the spring box 33. Incidentally, the moisture separating part 34 may be of another type such as a cyclone type instead of the silica gel type.

Besides, this embodiment is structured so that the air F21 that is to be supplied to the spring box 33 is adjusted by an air adjusting part 36, based on a pressure measured by a pressure measuring part 71 as illustrated in FIG. 6. Here, an information control device 361 is installed, and the information control device 361 controls the operation of the air adjusting part 36 based on the pressure measured by the pressure measuring part 71.

Concretely, the information control device 361 outputs a control signal S361 to the air adjusting part 36 according to pressure data S71 output by the pressure measuring part 71. When the pressure measured by the pressure measuring part 71 falls out of a predetermined range, the information control device 361 outputs the control signal S361 to the air adjusting part 36. Then, according to the control signal S361, the air adjusting part 36 adjusts the air F21 that is to be supplied to the spring box 33. Here, the air adjusting part 36 adjusts a flow rate of the air F21 that is to be supplied to the spring box 33 so that the pressure measured by the pressure measuring part 71 falls within the predetermined range. For example, when the pressure in the spring box 33 is lower than the predetermined range, the air adjusting part 36 increases the flow rate of the air F21. On the other hand, when the pressure in the spring box 33 is higher than the predetermined range, the air adjusting part 36 decreases the flow rate of the air F21.

### [B] Summary (Effect and so on)

As describe above, in this embodiment, the moisture contained in the air F21 that is to be supplied to the inlet 33A of the spring box 33 is separated and removed by the moisture separating part 34. Therefore, in this embodiment, since an amount of water contained in the supplied air F21 is small, it is possible to effectively prevent the generation of dew condensation inside the spring box 33.

Further, in this embodiment, the air adjusting part 36 automatically adjusts the air F21 that is to be supplied to the spring box 33, based on the pressure measured by the pressure measuring part 71. Therefore, it is possible to keep the pressure in the spring box 33 proper.

Therefore, in this embodiment, it is possible to effectively prevent a breakage and the like of an operating spring 33D.

### Fourth Embodiment

### [A] Structure

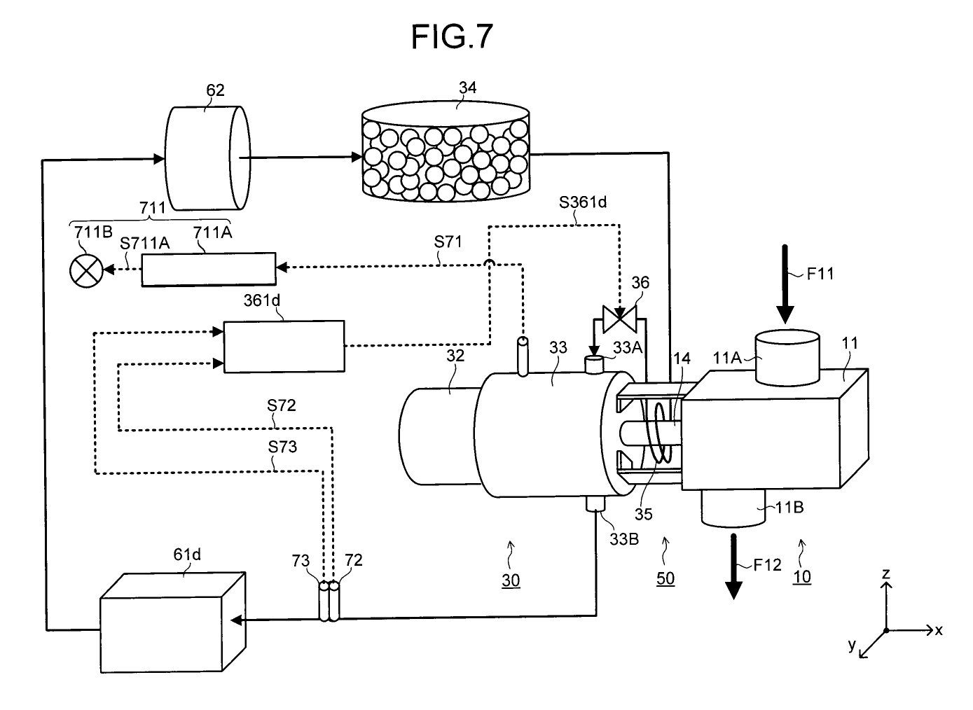

FIG. 7 is a view illustrating the whole structure of a steam valve in a fourth embodiment. In FIG. 7, as in FIG. 5, part thereof is illustrated in a perspective view, and an essential part is schematically illustrated. In FIG. 7, as in FIG. 5, the flow of steam is depicted by the thick solid line arrows, and the flow of the air is depicted by the thin solid line arrows. In addition, in FIG. 7, the flows of signals are depicted by the broken line arrows.

As illustrated in FIG. 7, in this embodiment, as is the case in the above-described second embodiment (refer to FIG. 5), a steam valve main body part 10, a steam valve driving part 30, and a yoke part 50 are provided. However, in this embodiment, the structure of the steam valve driving part 30 is partly different from that of the above-described second embodiment. Here, a part functioning as an air purge part of the steam valve driving part 30 is different from that of the above-described second embodiment. This embodiment is the same as the above-described second embodiment except in this point and points related to this. Therefore, in this embodiment, a description of what are the same as those described above will be omitted when appropriate.

In this embodiment, as is not the case in the second embodiment (refer to FIG. 5), an air supply part 61d does not supply the air F21 used in an instrumentation device (not illustrated) in a power plant (not illustrated), into a spring box 33. In this embodiment, the air supply part 61d includes an air tank and a blast pump (not illustrated), and the air F22 flowing out from an outlet 33B of the spring box 33 is stored in the air tank, and the stored air F22 is supplied to an inlet 33A of the spring box 33 by the blast pump (not illustrated).

In this embodiment, a filtering part 62 is provided as illustrated in FIG. 7, and the air F22 stored in the air tank of the air supply part 61d after flowing out from the outlet 33B of the spring box 33 is filtered by the filtering part 62. The filtering part 62 is a filtering device having a barrier filter and removes foreign matter contained in the air F22 stored in the air tank by the barrier filter. Then, the air F21 whose moisture is separated by a moisture separating part 34 after it is filtered by the filtering part 62 is heated in the yoke part 50 to flow into the inlet inlet 33A of the spring box 33. That is, in this embodiment, the air circulates in a closed cycle while undergoing the storage, the filtering, the drying, and the heating sequentially.

Besides, this embodiment is structured so that an air adjusting part 36 adjusts the air F21 that is to be supplied to the spring box 33, based on a temperature measured by a temperature measuring part 72 and humidity measured by a humidity measuring part 73 as illustrated in FIG. 7. Here, an information control device 361d is installed, and the information control device 361d controls the operation of the air adjusting part 36 based on the temperature measured by the temperature measuring part 72 and the humidity measured by the humidity measuring part 73.

Concretely, the information control device 361d outputs a control signal S361d to the air adjusting part 36 according to temperature data S72 output by the temperature measuring part 72 and humidity data S73 output by the humidity measuring part 73. For example, when the temperature measured by the temperature measuring part 72 and the humidity measured by the humidity measuring part 73 fall out of predetermined ranges, the information control device 361d outputs the control signal S361d to the air adjusting part 36. Then, according to the control signal S361d, the air adjusting part 36 adjusts a flow rate of the air F21 that is to be supplied to the spring box 33. For example, the air adjusting part 36 adjusts the flow rate of the air F21 that is to be supplied to the spring box 33 so that the temperature and the humidity fall within the predetermined ranges.

### [B] Summary (Effect and so on)

As described above, in this embodiment, the air adjusting part 36 automatically adjusts the air F21 that is to be supplied to the spring box 33, based on the temperature measured by the temperature measuring part 72 and the humidity measured by the humidity measuring part 73. Therefore, in this embodiment, it is possible to effectively prevent the generation of dew condensation inside the spring box 33.

Further, in this embodiment, the air F22 flowing out from the outlet 33B of the spring box 33 is filtered by the filtering part 62. Then, the air F21 from which the foreign matter is removed by the filtering in the filtering part 62 flows into the inlet 33A of the spring box 33. Therefore, in this embodiment, it is possible to effectively prevent the foreign matter from mixing into the spring box 33. Further, in this embodiment, due to the closed cycle in which the air supplied to the spring box 33 is circulated and used, the circulated air gradually becomes contaminated. Therefore, by providing the filtering part 62, it is possible to remove impurities causing the contamination.

Therefore, in this embodiment, it is possible to effectively prevent a breakage and so on of an operating spring 33D.

### [C] Modification Example

In this embodiment, the filtering part 62 is disposed downstream of the air tank of the air supply part 61d, but this is not restrictive. The filtering part 62 may be disposed upstream of the air tank of the air supply part 61d.

<Others>

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam valve driving device configured to adjust a flow rate of steam flowing inside a valve box by varying a distance between a valve seat and a valve element connected to a valve stem in the valve box, the device comprising:
an oil cylinder housing a piston connected to the valve stem via an operation rod, the piston being actuated according to the oil pressure; and
a spring box penetrated by the operation rod, the spring box housing an operating spring, the operating spring expanding and contracting when the operation rod is operated by the actuation of the piston,
wherein an inlet and an outlet are formed in the spring box, and an air from an outside of the spring box is supplied into the spring box from the inlet of the spring box so as to make a pressure in the spring box higher than a pressure of the outside, and is discharged from the outlet of the spring box.

2. The steam valve driving device according to claim 1,
wherein, in the spring box, the inlet is located above the outlet in a vertical direction.

3. The steam valve driving device according to claim 1,
comprising a moisture separating part which separates moisture contained in the air that is to be supplied to the spring box.

4. The steam valve driving device according to claim 1, comprising a heating part which heats the air that is to be supplied to the spring box.

5. The steam valve driving device according to claim 4, wherein the heating part heats the air that is to be supplied to the spring box, in a yoke part connecting the valve box and the spring box.

6. The steam valve driving device according to claim 1, comprising an air adjusting part which adjusts the air that is to be supplied to the spring box.

7. The steam valve driving device according to claim 1, comprising:
a pressure measuring part which measures a pressure in the spring box; and
a pressure warning part which gives a warning based on the pressure measured by the pressure measuring part.

8. The steam valve driving device according to claim 6, comprising a pressure measuring part which measures a pressure in the spring box,
wherein the air adjusting part adjusts the air that is to be supplied to the spring box, based on the pressure measured by the pressure measuring part.

9. The steam valve driving device according to claim 1, comprising:
a temperature measuring part which measures a temperature of the air flowing out of the outlet of the spring box; and
a temperature warning part which gives a warning based on the temperature measured by the temperature measuring part.

10. The steam valve driving device according to claim 6, comprising a temperature measuring part which measures a temperature of the air flowing out of the outlet of the spring box,
wherein the air adjusting part adjusts the air that is to be supplied to the spring box, based on the temperature measured by the temperature measuring part.

11. The steam valve driving device according to claim 1, comprising:
a humidity measuring part which measures humidity of the air flowing out of the outlet of the spring box; and
a humidity warning part which gives a warning, based on the humidity measured by the humidity measuring part.

12. The steam valve driving device according to claim 6, comprising a humidity measuring part which measures humidity of the air flowing out of the outlet of the spring box,
wherein the air adjusting part adjusts the air that is to be supplied to the spring box, based on the humidity measured by the humidity measuring part.

13. The steam valve driving device according to claim 1, comprising a filtering part which filters the air flowing out of the outlet of the spring box,
wherein the air having passed through the filtering part flows into the inlet of the spring box.

14. A steam valve comprising the steam valve driving device according to claim 1.
